(19) United States
(12) Patent Application Publication
(10) Pub. No.: US 2008/0121239 A1
(43) Pub. Date: May 29, 2008

(54) APPARATUS FOR ENHANCING SEXUAL INTIMACY

(76) Inventor: Dominic T. Hon, Houston, TX (US)

Correspondence Address: KEELING PATENTS AND TRADEMARKS, 3310 KATY FREEWAY, SUITE 100, HOUSTON, TX, 77007, US

(21) Appl. No.: 11/530,143

(22) Filed: Sep. 8, 2006

Related U.S. Application Data
(60) Provisional application No. 60/745,529.

(51) Int. Cl. A61G 15/00

(52) U.S. Cl. 128/845

(57) ABSTRACT

There is provided an apparatus for enhancing sexual intimacy. The apparatus comprises an elongated base having opposite ends and a pair of upstanding support members. One support member is connected to each end of the base. The base and the support members comprise a frame. A seat is disposed between the support members. The seat is vertically movable between an upper position and a lower position with respect to the support members. The seat is supported by a pair of springs and by a flexible bridge connected to the seat.

### CROSS-REFERENCE TO RELATED APPLICATIONS

This application claims the benefit of U.S. Provisional Patent Application No. 60/745,529 entitled, “Apparatus for Enhancing Sexual Intimacy,” filed on Apr. 24, 2006 in the United States Patent and Trademark Office.

### STATEMENT REGARDING FEDERALLY SPONSORED RESEARCH OR DEVELOPMENT

Not Applicable.

### BACKGROUND OF THE INVENTION

1. Field of the Invention

This invention relates generally to an apparatus for supporting the human body, and more particularly to an apparatus for enhancing sexual intimacy by providing support and enhanced movement to the user.

2. Description of the Related Art

Devices already known in the art are bulky and do not adequately enhance sexual intimacy. U.S. Pat. No. 6,698,431 teaches a hydraulic apparatus for supporting one partner, while allowing the other partner to remain standing. While the apparatus provides hydraulic movement, the movement is minimal and does not achieve meaningful enhancement of the user's movements.

U.S. Pat. No. 5,443,532 teaches a frame supporting an inclined platform.

A need therefore exists for a device that more adequately enhances sexual intimacy.

### BRIEF SUMMARY OF THE INVENTION

The present invention addresses the aforementioned need. The invention overcomes many of the shortcomings of the prior art by providing an improved apparatus for supporting a user during sexual intimacy, while also enhancing the user's movements. That apparatus comprises a support frame, with two arms upwardly extending from the base. A seat is suspended between the two arms. The objects of the invention are apparent from the following description, the claims set forth below, and the accompanying drawings.

### BRIEF DESCRIPTION OF THE DRAWINGS

For a more complete understanding of the present invention and the advantages thereof, reference is now made to the following Detailed Description of an Example Embodiment of the Invention, taken in conjunction with the accompanying drawings. in which:

FIG. 1 is a perspective view of the apparatus of the present invention.

FIG. 2A is a cross-sectional, elevation view of the apparatus taken along line 2-2 in FIG. 1, with the seat in the raised position.

FIG. 2B is a cross-sectional, elevation view of the apparatus taken along line 2-2 in FIG. 1, with the seat in the lowered position.

FIG. 3 is a bottom view of the seat of the apparatus of the invention.

FIG. 4 is a detail perspective view of a roller for the bridge of the invention.

FIG. 5 is an exploded, perspective view of some of the components of the roller of FIG. 4.

FIG. 6A is a perspective view of a frame for the apparatus according to an alternative embodiment of the invention.

FIG. 6B is a detail plan view of a top member of the frame of FIG. 6A.

### DETAILED DESCRIPTION OF THE INVENTION

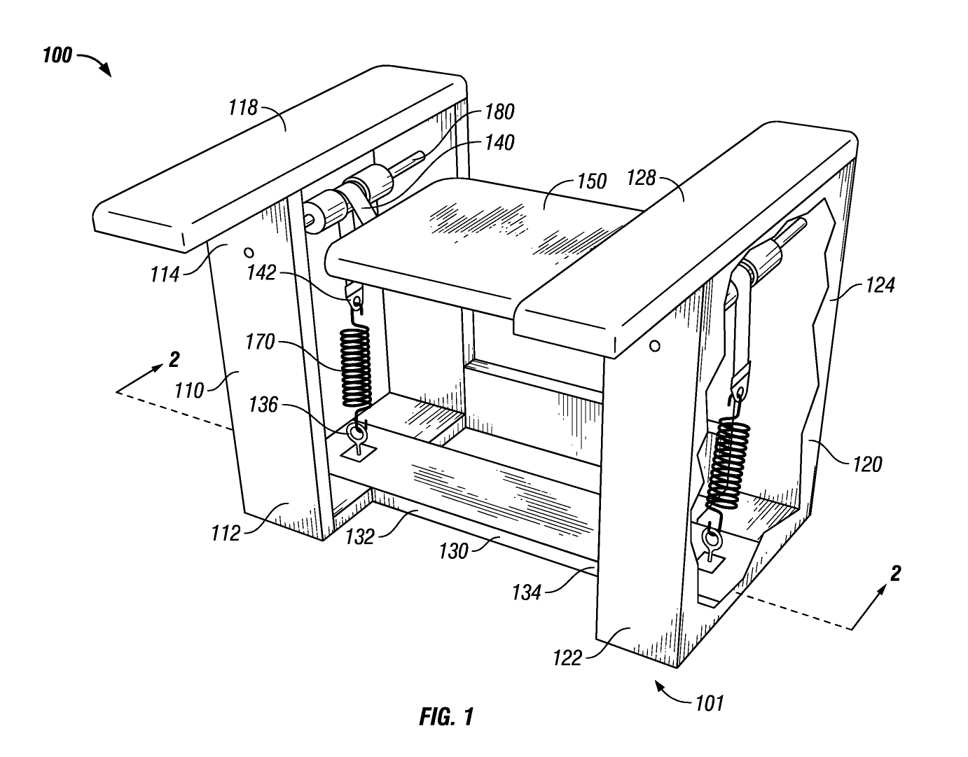

The invention and its advantages are best understood by referring to the drawings, like numerals being used for like and corresponding parts of the various drawings. In FIG. 1 there is shown in perspective view an apparatus for enhancing sexual intimacy, generally designated 100, according to an example embodiment of the invention.

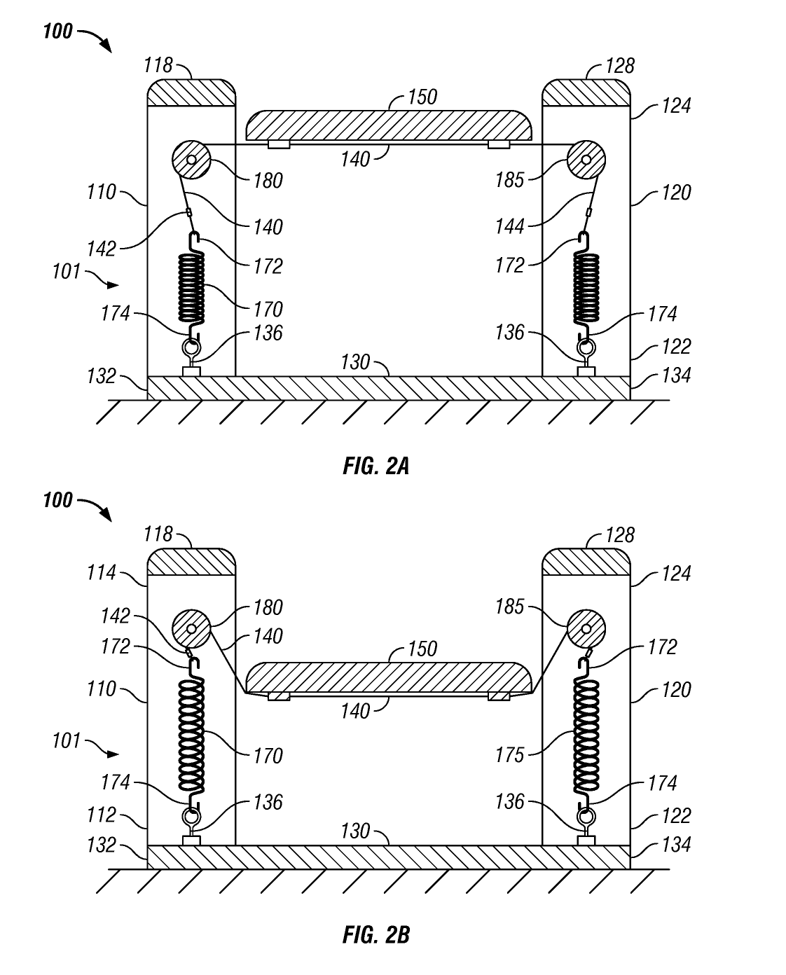

In the preferred embodiment, apparatus 100 generally comprises frame 101 and seat 150. As seen in FIGS. 1, 2A, and 2B, frame 101 is comprised of a pair of support members 110 and 120 extending upwardly from base 130. Base 130 is generally planar, with a base first end 132 and a base second end 134. First support member 110 is generally U-shaped, thereby creating a cavity for retaining the mechanics of apparatus 100. First support member 110 has a first support member first end 112 and a first support member second end 114. Similarly, second support member 120 is generally U-shaped, and has a second support member first end 122 and a second support member second end 124. First and second support members 110 and 120 are preferably sized, such that the user will be aligned with the standing individual, however first and second support members 110 and 120 can be of any height. Armrests 118 and 128 are attached to the tops of support members 110 and 120, respectively.

In the preferred embodiment, at least two support members 110 and 120 are oppositely aligned, and attached to base 130. Support members 110 and 120 can be fixedly attached to base 130, as seen in FIGS. 1, 2A, and 2B, or integrally formed (not shown) with base 130. First support member first end 112 is fixedly attached to base 130 proximate base first end 132, and second support member second end 122 is fixedly attached to base 130 proximate base second end 134. Support members 110 and 120 are preferably perpendicular with respect to base 130. However, support members 110 and 120 can be of any angle with respect to base 130 as long as frame 101 provides adequate support for at least one human. Frame 101 can be made of any material, however for maximum support, steel is preferred. Additionally, to make apparatus 100 more aesthetically pleasing, frame 101 may be surrounded by wood and upholstered in vinyl or leather.

Referring to FIGS. 1, 2A, and 2B, base 130 has at least one anchor 136 fixedly attached proximate base first end 132. Base 130 also has at least one anchor 136 fixedly attached proximate base second end 134. To ensure the mechanical components are retained within the cavity created by first and second support members 110 and 120, anchor 136 is preferably attached intermediate base first end 132 and the terminal points of the generally U-shaped first support member 110. Similarly, anchor 136 is preferably attached intermediate base second end 134 and the terminal points of the generally U-shaped second support member 120. Anchors 136 provides an anchor attachment point for springs 170 and 175. Accordingly, anchors 136 preferably includes a loop or eye or similarly constructed attachment means for retaining one end of springs 170 and 175.

Springs 170 and 175 provide vertical movement to apparatus 100. Referring to FIGS. 2A and 2B, spring 170 has a first spring end 172 and a second spring end 174. Second spring end 174 provides a loop for attaching to anchor 136. First spring end 172 forms a loop for attachment to bridge 140. At least two springs 170 and 175 are attached to base 130, wherein at least one spring 170 is attached to anchor 136 proximate base first end 132 and at least one spring 175 is attached to anchor 136 proximate base second end 134.

Bridge 140 provides support for seat 150. Bridge 140 has a bridge first end 142 and a bridge second end 144. Bridge 140 extends between spring 170, attached to anchor 136 on base first end 132, and spring 175 attached to anchor 136 on base second end 134. Bridge 140 can be made of any material of sufficient strength for withstanding the forces applied by at least one human being, but is preferably a woven nylon material.

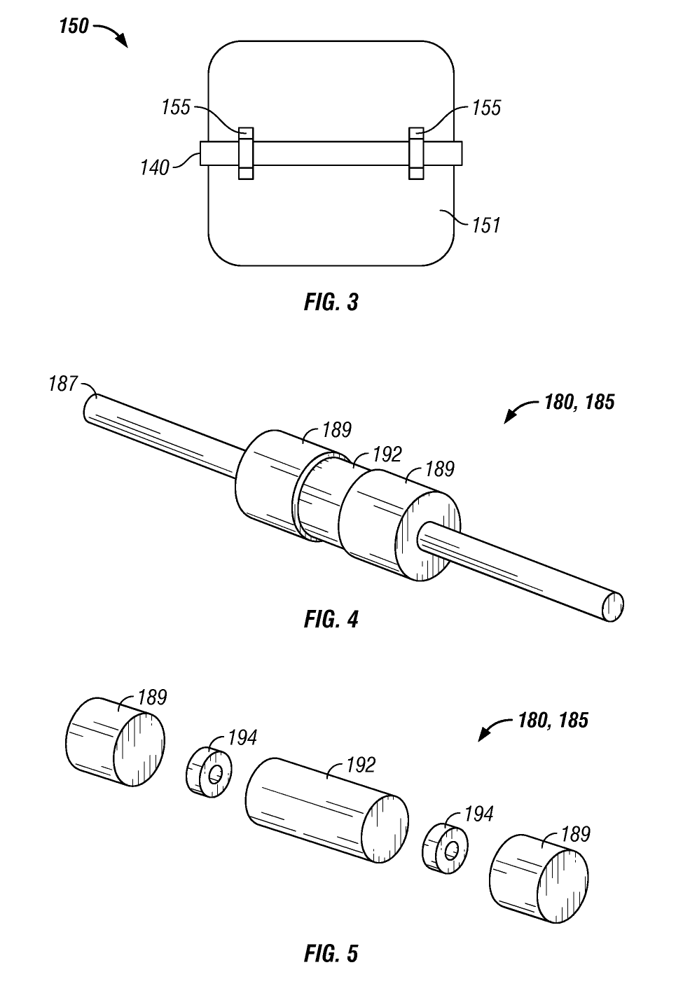

Referring to FIG. 3, the seat bottom surface 151 of seat 150 is depicted. At least two clamps 155 are mounted to the bottom of seat 151 by screws, bolt, or other attachment means. Clamps 155 secure the center portion of bridge 140 to seat 150, and permit seat 150 and its occupant to be supported by bridge 140.

Bridge 140 is aligned such that the center portion of bridge 140 extends across the middle of seat bottom surface 151, thereby leaving an equal portion of bridge 140 extending freely on each side of seat bottom surface 151.

Referring to FIGS. 1, 2A, and 2B, first roller 180 is retained proximate first support member second end 114 within the cavity created by the U-configuration. First roller 180 is attached such that first roller 180 remains freely rotatable. Similarly, second roller 185 is retained proximate second support member second end 124 within the cavity created by the U-configuration.

FIG. 4 is a detail view of first and second rollers 180 and 185. Rollers 180 and 185 are made up of a shaft 187, a cylinder 192, and a pair of caps 189. Referring to FIG. 5, bearings 194 fit within the ends of cylinder 192 and support cylinder 192 rotatably on shaft 187. Bearings 194 are not fixed in place on shaft 187, but are free to slide axially along shaft 187 in response to axial forces applied to rollers 180 and 185. This axial freedom of movement of bearings 194 permits corresponding axial movement of rollers 180 and 185 in response to lateral movement of seat 150.

Caps 189 slide over the ends of cylinder 192 and provide additional surface for bridge 140. The opposite ends of shaft 187 are supported by support members 110 and 120. In one example embodiment of the invention, cylinder 192 and caps 189 comprise polyvinyl chloride (PVC) and bearings 194 are commercially available ball bearings.

Bridge 140 is fed over first roller 180 and over second roller 185. Bridge first end 142 is fixedly attached to at least one spring 170 first end 172, and bridge second end 144 is fixedly attached to at least one spring 175 first end 172. In practice, apparatus 100 can be used alone, or apparatus 100 can be positioned against a wall, couch, bed, or other object. One user can sit on seat 150, while the second user can remain standing. Seat 150 is biased in the upper position by springs 170 and 175. The weight and movement of the seated person will exert a downward force against the seat, which is transferred to first and second springs 170 and 175 through bridge 140. Springs 170 and 175 have a linear variation of extension upon the application of the force, thereby causing springs 170 and 175 to vertically extend upward. As the force is removed, springs 170 and 175 vertically retract downward, thereby enhancing the upward movement of the seated user. Once springs 170 and 175 reach their tension point, the springs will inhibit further vertical movement of the seat.

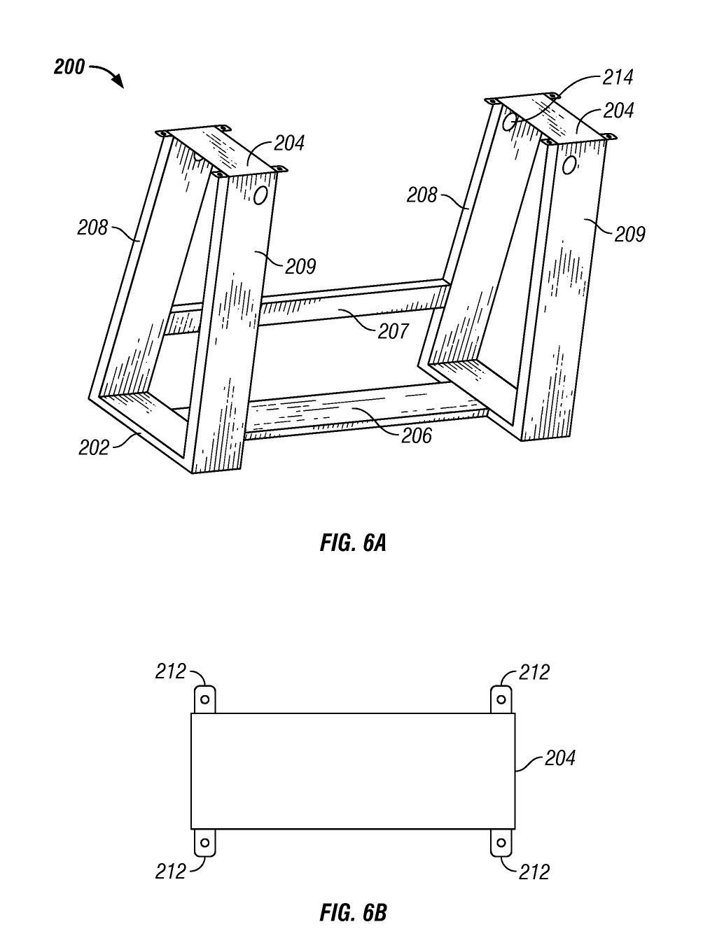

FIG. 6A illustrates a frame 200 according to an alternative embodiment of the invention. Frame 200 is generally A-shaped, with wider base members 202 than top members 204 for increased stability and resistance to tip over. In one example embodiment, the members 202, 206, 207, 208, and 209 of frame 200 all comprise rectangular steel tubing, and top member 204 comprises gauge 12 steel plate. As seen in FIG. 6B, top members 204 include horizontally extending ears 212. Screw holes are provided in ears 212 for attaching arm rests 118 and 128 to top members 204. Holes 214 are provided near the tops of frame members 209 for mounting rollers 180 and 185 therein.

The apparatus for enhancing sexual intimacy of the present invention, and many of its intended advantages, will be understood from the foregoing description of an example embodiment, and it will be apparent that, although the invention and its advantages have been described in detail, various changes, substitutions, and alterations may be made in the manner, procedure, and details thereof without departing from the spirit and scope of the invention, as defined by the appended claims, or sacrificing any of its material advantages, the forms hereinbefore described being merely an exemplary embodiment thereof.

1. An apparatus for enhancing sexual intimacy, which comprises:
an elongated base having opposite ends;
a pair of upstanding support members, one support member connected to each end of the base, the base and the support members comprising a frame;
a seat disposed between the support members, the seat movable with respect to the frame and laterally movable in relation to the base of the frame, the seat biased in an upper position at least in part by at least one spring;
the seat supported in part by a pair of springs, one spring being disposed within each support member;
the seat also supported by a bridge having opposite ends and a center, the center of the bridge passing under and supporting the seat, each end of the bridge connected to a respective spring.

2-5. (canceled)

6. The apparatus of claim 1, further comprising at least one roller attached to the frame, and wherein the bridge is supported on the rollers.

7. The apparatus of claim 1, further comprising a pair of rollers attached to the frame, and wherein the bridge is supported on the pair of rollers.

8. The apparatus of claim 1, wherein the bridge is flexible.

9. The apparatus of claim 8, wherein a downward force applied to the seat applies a tensile force to the springs through the bridge, thereby extending the springs so that the seat is lowered.

10. The apparatus of claim 7, wherein each roller comprises:
a shaft,
at least one bearing rotatably connected to the shaft; and
a cylinder supported by the shaft and by the bearings and rotatable with respect to the shaft when the seat moves with respect to the frame.

11. The apparatus of claim 10, wherein the cylinder is laterally movable in relation to the shaft when the cylinder is rotating with respect to the shaft.

12. The apparatus of claim 10, further including at least one cap attached to an end of the cylinder.

13. The apparatus of claim 10, further including a cap attached to each end of the cylinder.

14. The apparatus of claim 1, further including an armrest attached to the top of each support member.

15. An apparatus for enhancing sexual intimacy, which comprises:
an elongated base having opposite ends;
a pair of upstanding support members, one support member connected to each end of the base, the base and the support members comprising a frame;
a seat disposed between the support members and movable with respect to the frame,
at least one spring disposed on each side of the apparatus, each spring having a lower end and an upper end, each spring lower end attached to the frame;
a flexible bridge connecting the upper ends of the springs with the seat so that a downward force applied to the seat applies a tensile force to the springs through the flexible bridge, thereby extending the springs so that the seat is lowered.

16. The apparatus of claim 15, further comprising at least one roller attached to the frame, and wherein the flexible bridge is supported on the rollers.

17. The apparatus of claim 15, further including a pair of rollers attached to the frame, and wherein the flexible bridge is supported on the pair of rollers.

18. The apparatus of claim 17, further including an armrest attached to the top of each support member.

19. The apparatus of claim 18, wherein each roller comprises:
a shaft;
at least one bearing rotatably connected to the shaft;
a cylinder supported by the shaft and by the bearings and rotatable with respect to the shaft when the seat moves with respect to the frame; and
at least one cap attached to an end of the cylinder.

20. The apparatus of claim 15, wherein the frame is A-shaped, having a wider bottom than top.
